(19) United States
(12) Patent Application Publication
(10) Pub. No.: US 2018/0081970 A1
(43) Pub. Date: Mar. 22, 2018

(54) DATA RETRIEVAL SYSTEM AND DATA RETRIEVAL METHOD

(71) Applicant: Kabushiki Kaisha Toshiba, Minato-ku (JP)

(72) Inventors: Makoto SHIMAMURA, Kawasaki (JP); Yoshiei SATO, Ota (JP); Mototaka KANEMATSU, Yokohama (JP)

(73) Assignee: Kabushiki Kaisha Toshiba, Minato-ku (JP)

(21) Appl. No.: 15/694,419

(22) Filed: Sep. 1, 2017

(30) Foreign Application Priority Data
Sep. 20, 2016 (JP) 2016-182800

(51) Int. Cl. G06F 17/30; H04L 29/08

(52) U.S. Cl. CPC G06F 17/30864; H04L 67/1008; H04L 67/1034; H04L 67/12

(57) ABSTRACT

A data retrieval system includes a first apparatus and a second apparatus. The first apparatus includes a distributor, a processing state receptor, and a completion determiner. The distributor distributes a query to one or more devices which can retain data. The processing state receptor receives, from the second apparatus, information indicating processing states of the devices for the query. The completion determiner determines whether the query is complete from the received processing state. The second apparatus includes a transceiver, a process manager, and a processing state transmission controller. The transceiver receives a query distributed by the first apparatus and transmits the query to the devices. The process manager manages a processing state indicating whether each device completes the query on the basis of a received processing result of the query of each device. The processing state transmission controller transmits managed processing states of the query to the first apparatus.

### CROSS-REFERENCE TO RELATED APPLICATION

This application is based upon and claims the benefit of priority from Japanese Patent Application No. 2016-182800, filed Sep. 20, 2016; the entire contents of which are incorporated herein by reference.

Embodiments described herein relate generally to a data retrieval system and a data retrieval method.

### BACKGROUND

There is a conventional data retrieval system that retrieves data retained in each of Internet of Things (IoT) devices capable of retaining data from a server connected to a plurality of IoT devices. However, in the conventional retrieval system, when there is an IoT device for which retrieval has failed due to device failure, network failure or the like, all retrieval processes may become error control because a plurality of IoT devices are connected to the server. In addition, in the conventional retrieval system, processes are concentrated on the server and thus the processing load increases in some cases.

### BRIEF DESCRIPTION OF THE DRAWINGS

FIG. 1 is a diagram illustrating a functional configuration example of a data retrieval system 1 of embodiments.

FIG. 2 is a diagram illustrating content of data of a GW query management table 154.

FIG. 3 is a diagram illustrating an example of data of a device query management table 242.

FIG. 4 is a diagram for describing a state of query distribution from a server 100.

FIG. 5 is a diagram illustrating an example of the device query management table 242 having processing states obtained from a controlled device 300.

FIG. 6 is a diagram illustrating an example of the device query management table 242 having processing states obtained from a controlled gateway 200.

FIG. 7 is a diagram illustrating an example of a device query management table 242A including database sizes.

FIG. 8 is a diagram illustrating an example of a device query management table 242B including table sizes.

FIG. 9 is a flowchart illustrating an example of content of a process in the server 100 of embodiments.

FIG. 10 is a flowchart illustrating an example of content of a process in the gateway 200 of the embodiments.

FIG. 11 is a flowchart illustrating an example of content of a process in the device 300 of the embodiments.

### DETAILED DESCRIPTION

A data retrieval system of embodiments includes a first apparatus and a second apparatus. The first apparatus includes a distributor, a processing state receptor, and a completion determiner. The distributor distributes a query to one or more devices which are able to retain data. The processing state receptor receives, from the second apparatus, information indicating processing states of the query in the one or more devices. The completion determiner determines whether the query is completed from the processing state received by the processing state receptor. The second apparatus includes a transceiver, a process manager, and a processing state transmission controller. The transceiver receives a query distributed by the first apparatus and transmits the query to the one or more devices. The process manager manages a processing state indicating whether each of the one or more devices completes the query on the basis of a processing result of the query of each of the one or more devices received by the transceiver. The processing state transmission controller transmits processing states of the query managed by the process manager to the first apparatus using the transceiver.

A data retrieval system and a data retrieval method of embodiments will be described below with reference to the drawings.

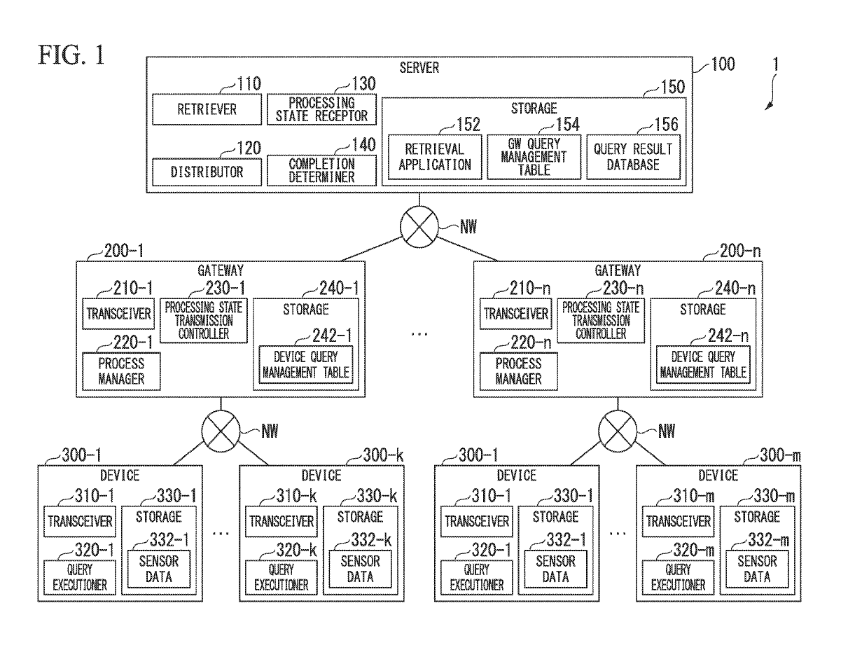

FIG. 1 is a diagram illustrating a functional configuration example of a data retrieval system 1 of the embodiments. For example, the data retrieval system 1 illustrated in FIG. 1 includes a server (first apparatus) 100, one or more gateways (second apparatuses) 200-1 to 200-n, and one or more devices 300-1 to 300-k (or m). k and m are variables which may be the same number or different numbers.

The server 100, the gateways 200 and the devices 300 communicate via networks NW including the Internet, a local area network (LAN), a wide area network (WAN) and the like. Meanwhile, in the following description, the gateways 200-1 to 200-n have the same configuration, and when they are not discriminated from one another, signs after hyphens which indicate the gateways are omitted and they are referred to as “gateway 200.” In addition, the same applies to other components indicated using hyphens. Furthermore, the data retrieval system 1 of the embodiments may include a plurality of servers 100, and the gateways 200 may be configured in a plurality of layers.

First, a functional configuration example of the server 100 will be described. For example, the server 100 includes a retriever 110, a distributor 120, a processing state receptor 130, a completion determiner 140, and a storage 150. The retriever 110, the processing state receptor 130 and the completion determiner 140 are realized by execution of a program (e.g., a retrieval application 152) stored in the storage 150 by a processor such as a central processing unit (CPU). For example, the program may be downloaded from an application server (not shown) via a network NW, or a program stored in a portable storage medium such as an SD card may be installed in the server 100. In addition, some or all of the above-described functions may be realized by hardware such as large scale integration (LSI), an application specific integrated circuit (ASIC), and a field-programmable gate array (FPGA) or realized by software and hardware in cooperation.

The retriever 110 issues a query for acquiring data retained in the one or more devices 300. For example, the query is a command indicating a manipulation for data retained in the device 300. For example, the query is a command described in a standard query language (SQL). For example, the query may be a command for acquiring, from the device 300, a power consumption amount, a consumed gas amount, a tap water consumption amount, and the like from Sep. 14 to Sep. 21, 2016 in association with time information, or a command for acquiring a temperature, humidity, and the like at the present time. Furthermore, the query may be a command for acquiring all the data retained in the device 300 regardless of the time information.

The retriever 110 outputs a query to be executed by the device 300 and a query ID for identifying the query to the distributor 120. In addition, the retriever 110 creates a GW query management table 154 for managing a query state for each gateway 200.

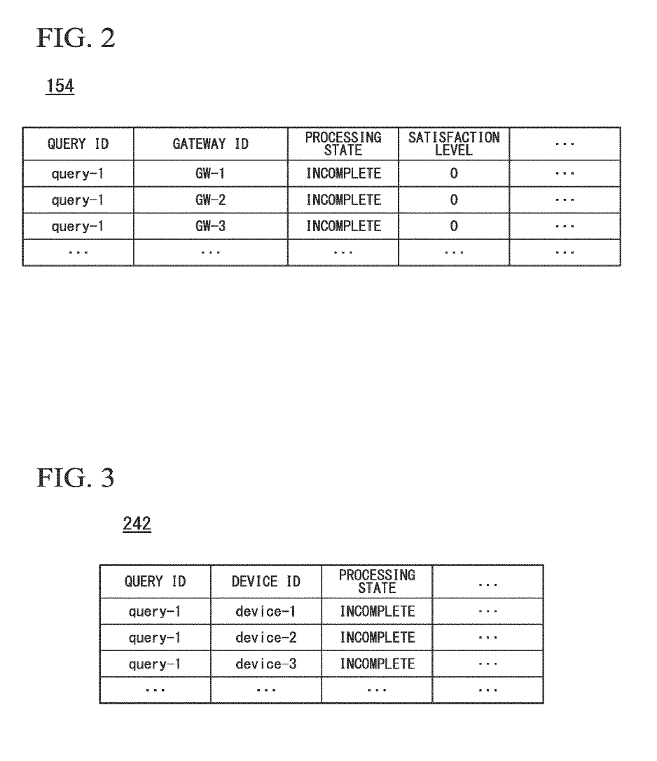

FIG. 2 is a diagram illustrating content of data of the GW query management table 154. For example, the GW query management table 154 is information in which “processing state” and “satisfaction level” are associated with “query ID” and “gateway ID.” The “query ID” is identification information of a query instructed to be executed by the retriever 110. The gateway ID” is identification information of the gateway 200. The “processing state” is information indicating a processing state of a query for each gateway 200. For example, when the processing state receptor 130 has received a GW query completion message from the gateway 200, a processing state is information indicating “complete.” On the other hand, when the GW query completion message has not been received, a processing state is information indicating “incomplete.”

“Satisfaction level” is a degree of satisfaction with respect to a query processing result determined by the completion determiner 140 after a processing state has been received. For example, the satisfaction level may be calculated by dividing the number of devices which have correctly completed a query by the number of devices required to process the query. The retriever 110 stores the aforementioned query ID, gateway ID, processing state and satisfaction level as a set in the GW query management table 154 when a query is distributed from the distributor 120. Here, as initial values, “incomplete” is stored as a processing state and “0” is stored as a satisfaction level.

The distributor 120 distributes a query and a query ID acquired from the retriever 110 to the gateway 200.

The processing state receptor 130 receives, from the gateway 200, query processing results or processing states obtained by the one or more devices 300 after the query has been distributed by the distributor 120 to the gateway 200. When the query processing results are received, the processing state receptor 130 stores the query processing results in a query result database 156. The processing state receptor 130 updates processing states of the GW query management table 154 stored in the storage 150 on the basis of the received processing state of each gateway 200.

The completion determiner 140 determines whether the query has been completed from the processing states received by the processing state receptor 130. For example, the completion determiner 140 calculates a satisfaction level from the processing state of each gateway with reference to the GW query management table 154 stored in the storage 150.

In addition, the completion determiner 140 determines that the executed query has succeeded when the calculated satisfaction level is equal to or greater than a predetermined threshold value (e.g., 80%). The fact that a query has succeeded means, for example, that a processing result obtained by execution of the query is determined as a valid result.

The storage 150 is realized by a random access memory (RAM), a read only memory (ROM), a hard disk drive (HDD), a flash memory or the like. For example, the storage 150 stores the retrieval application 152, the GW query management table 154, and information of the query result database 156. For example, the server 100 may be a personal computer (PC) or a cloud server including a plurality of information processing apparatuses.

Next, the functional configuration of the gateway 200 will be described. For example, the gateway 200 includes a transceiver 210, a process manager 220, a processing state transmission controller 230, and a storage 240. In addition, one or both of the aforementioned process manager 220 and processing state transmission controller 230 may be realized by hardware such as an LSI, an ASIC and an FPGA or realized by software and hardware in cooperation.

The transceiver 210 receives a query distributed by the server 100. In addition, the transceiver 210 transmits the received query to the one or more devices 300 under the control of the gateway 200.

The process manager 220 manages a query processing result of each of the one or more devices 300 that has been received by the transceiver 210 through a device query management table 242 stored in the storage 240.

FIG. 3 is a diagram illustrating an example of data of the device query management table 242. For example, the device query management table 242 is information in which “processing state” is associated with “query ID” and “device ID.” “Device ID” is information for identifying a device. “Processing state” is a processing state of a query for each device ID.

For example, the process manager 220 sets “incomplete” immediately after a query is distributed to each device 300 because a process for the query has not been completed. In addition, when a processing result has been received from the device 300, the process manager 220 sets “complete” for the processing state of the target device 300. Furthermore, when a processing result is obtained after a lapse of predetermined time after a query has been distributed to the device 300, the process manager 220 sets information indicating a timeout error, a communication error or the like as the processing state. Meanwhile, the predetermined time may be set for each query, for example.

The processing state transmission controller 230 transmits the query processing states managed by the process manager 220 to the server 100 using the transceiver 210.

The storage 240 is realized by a RAM, a ROM, an HDD, a flash memory or the like. For example, the storage 240 stores information of the device query management table 242. For example, the gateway 200 may have a function of performing protocol conversion between networks.

In addition, the gateway 200 may be a relay apparatus such as a router apparatus or a hub apparatus.

Next, a functional configuration example of the device 300 will be described. For example, the device 300 includes a transceiver 310, a query executioner 320, and a storage 330. The query executioner 320 may be realized by hardware such as an LSI, an ASIC and an FPGA, or realized by software and hardware in cooperation.

The transceiver 310 receives a query distributed by the gateway 200. In addition, the transceiver 310 outputs a result of the query executed in the query executioner 320 to the gateway 200 that has distributed the query.

The query executioner 320 executes the query received by the transceiver 310. For example, the query executioner 320 extracts data corresponding to the query among sensor data 332 stored in the storage 330. For example, the sensor data 332 is at least one piece of data such as a temperature, humidity, power consumption, a consumed gas amount, and a tap water consumption amount which are acquired in a place where the device 300 is installed at each predetermined time intervals. The sensor data 332 may be stored together with time information.

The storage 330 is realized by a RAM, a ROM, an HDD or a flash memory. For example, the storage 330 stores information of the sensor data 332. For example, the device 300 is an IoT device.

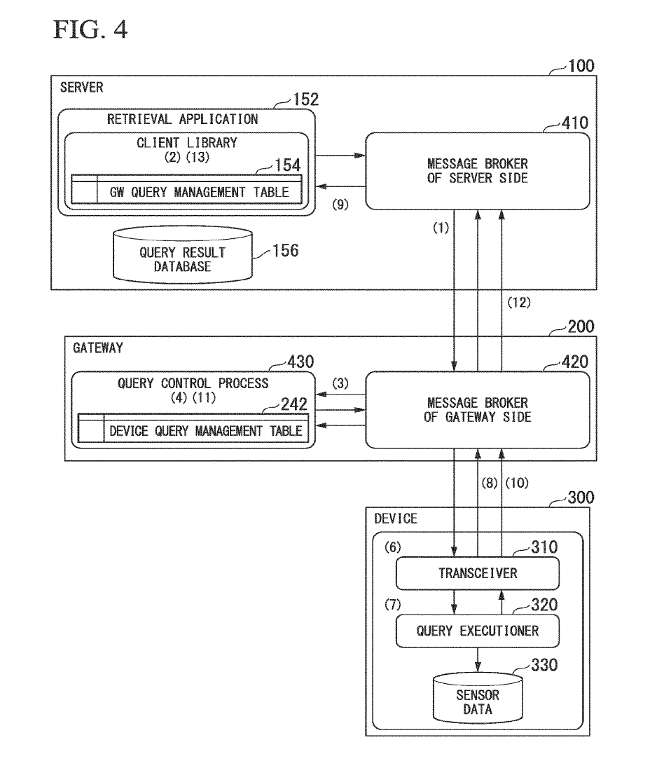

Various operations of a retrieval process in the server 100 will be described below. FIG. 4 is a diagram for describing a state of query distribution from the server 100. Meanwhile, FIG. 4 shows an example in which one server 100, one gateway 200 and one device 300 are connected for simplification of the description.

The retrieval application 152 of the server 100 causes a message broker 410 of the server side to transmit a query ID and a query to all gateways 200 ((1) in the figure). Meanwhile, the message broker 410 of the server side corresponds to the distributor 120, for example. Furthermore, the retrieval application 152 generates the GW query management table 154 in a library thereof (client library) ((2) in the figure).

Then, when a message broker 420 of the gateway side of the gateway 200 receives the query ID and the query from the server 100, the message broker 420 outputs the received information to a query control process 430 ((3) in the figure). For example, the message broker 420 of the gateway side corresponds to the transceiver 210. In addition, for example, the query control process 430 corresponds to the process manager 220 and the processing state transmission controller 230.

The query control process stores the transmitted query ID in the device query management table 242 and performs data entry ((4) in the figure). Subsequently, the message broker 420 of the gateway side transmits the query ID and the query to the device 300 ((5) in the figure).

The transceiver 310 of the device 300 receives the query ID and the query from the gateway 200 ((6) in the figure). The query executioner 320 executes the query, acquires data corresponding to the query from the sensor data 332, and creates ResultSet of a retrieval result ((7) in the figure). ResultSet is a response of a database management system (DBMS) or the like for a query and, for example, an object including an execution result of an SQL query. As a DBMS retrieval result, for example, data indicating part of a table becomes ResultSet.

Thereafter, the query executioner 320 transmits the created ResultSet using the transceiver 310 to the server 100 via the gateway 200 ((8) in the illustration). The server 100 receives ResultSet ((9) in the illustration). Data corresponding to the received ResultSet is stored in the query result database 156. Then, the query executioner 320 transmits a query completion message to the query control process 430 when the query is complete ((10) in the illustration).

Subsequently, the message broker 420 of the gateway side outputs the query completion message to the query control process 430. The query control process 430 determines whether the query completion message has been received or a timeout error has been detected for all the controlled devices 300 ((11) in the illustration). In addition, the query control process 430 transmits a GW query completion message to the server 100 when the query completion message has been received or the timeout error has been detected for all the controlled devices 300 ((12) in the illustration). The GW query completion message transmitted from the query control process 430 includes information about the ratio of success or failure of the query of the controlled devices 300.

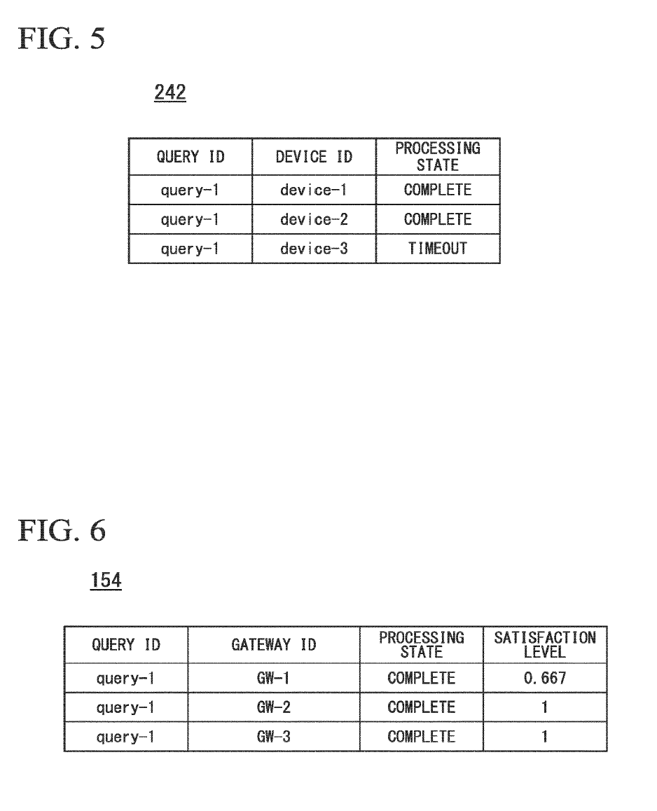

FIG. 5 is a diagram illustrating an example of the device query management table 242 having processing states obtained from the controlled device 300. For example, the query control process 430 has device IDs “device-1” to “device-3” of devices 300 under the control of the gateway 200.

In this case, in the query control process 430, processing states with respect to the device IDs “device-1” and “device-2” are set to “complete” for the query ID “query-1” and a processing state with respect to the device ID “device-3” is set to be a timeout error. In this case, since two of the three devices 300 have succeeded in the query, the query control process 430 outputs information about a ratio such as a success rate of 2/3≈0.667 to information about the GW query completion message. Meanwhile, the aforementioned information about the ratio is an example of the “satisfaction level.”

Then, the retrieval application 152 receives GW query completion messages with respect to all the controlled gateways and determines success or failure in the query on the basis of the received GW query completion messages.

FIG. 6 is a diagram illustrating an example of the device query management table 242 having processing states obtained from the controlled gateway 200. For example, the server 100 is assumed to have three gateways GW1 to GW3 under the control thereof. In addition, it is assumed that a certain gateway ID “GW-1” corresponds to a gateway which fails in query processing in one of three devices 300 under the control thereof. In this case, a satisfaction level corresponding to the gateway ID “GW-1” is 0.667. In addition, the gateways corresponding to other gateway IDs “GW-2” and “GW-3” obtain normal processing results from all the devices 300 under the control thereof. Accordingly, the satisfaction levels corresponding to the gate IDs “GW-2” and “GW-3” become 1. Accordingly, a total satisfaction level of the query results becomes 2.667/3≈0.89, which is obtained by dividing the sum of all satisfaction levels of the respective gateways 200 by the number of gateways 200.

Here, the retrieval application 152 determines that the query has succeeded when the satisfaction level of the query is equal to or greater than a predetermined threshold value (e.g., 0.8). In this case, the aforementioned value 0.89 exceeds 0.8 and thus the retrieval application 152 determines that the query has succeeded.

Here, although the above-described process obtains a satisfaction level of a query result for each gateway 200, embodiments of the present invention are not limited thereto. For example, the gateway 200 may obtain a satisfaction level depending on the number of devices 300 under the control thereof. In this case, the gateway 200 transmits a satisfaction level Sn of a query result and the number Nn of devices under the control thereof (e.g., n refers to n-th) to the server 100.

The retrieval application 152 of the server 100 divides the sum of products of the satisfaction levels Sn of query results of the gateways 200 and the number Nn of devices under the control thereof by the sum of the number Nn of devices (Σ(Sn×Nn)/ΣNn), and when the divided value is equal to or greater than a threshold value, determines that the corresponding query has succeeded.

In addition, the gateway 200 may calculate a satisfaction level on the basis of a data size of the sensor data 332 retained in the device 300. For example, the data size may be a database size or a table size. For example, when a satisfaction level is calculated on the basis of a database size, the satisfaction level is determined by a success rate for the entire database size. In this case, the gateway 200 receives a database size Dm retained in a controlled device in advance at a query issuance time. Here, the database size can be acquired by issuing a database size acquisition query at the same time when a query is issued. The acquired database size is added to each entry of the device query management table 242.

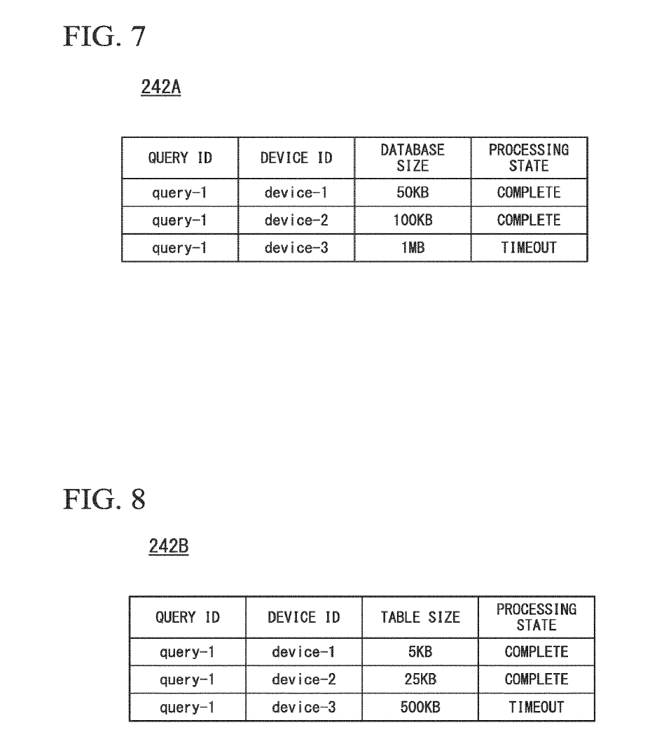

FIG. 7 is a diagram illustrating an example of a device query management table 242A including database sizes. The device query management table 242A stores a database size of the sensor data 332 of the device 300 corresponding to each device ID in addition to query IDs, device IDs and processing states.

The gateway 200 transmits, to the server 100, the sum En(=ΣDm′ (m′ indicates devices 300 that have succeeded)) of database sizes retained in devices 300 that have succeeded in the query and the sum Dn(=ΣDm) of database sizes retained in devices 300 required to process the query when the query is complete. The server 100 acquires a satisfaction level of a query result by calculating “ΣEn/ΣDn” on the basis of the two obtained values. Here, the aforementioned satisfaction level of the query result may be calculated in the gateway 200 and the calculated result may be transmitted to the server 100.

Furthermore, when a satisfaction level of a query result is calculated on the basis of a table size related to a query, the gateway 200 acquires a table size Tm of a table related to the query in advance. The acquired table size is added to each entry of the device query management table 242.

FIG. 8 is a diagram illustrating an example of a device query management table 242B including table sizes. The device query management table 242B stores a table size of the device 300 corresponding to each device ID in addition to query IDs, device IDs and processing states.

The gateway 200 transmits, to the server 100, the sum Tn(=εTm′) of table sizes related to devices 300 that have succeeded in the query and the sum Un(=ΣTm) of table sizes related to devices 300 required to process the query.

The server 100 acquires a satisfaction level of a query result by calculating “ΣTn/ΣUn” on the basis of the two obtained values. The aforementioned satisfaction level of the query result may be calculated in the gateway 200 and the calculated result may be transmitted to the server 100. Meanwhile, in the above-described methods of calculating a satisfaction level of a query result in consideration of a database size and a table size, the aforementioned query result satisfaction level can easily be calculated in the case of a data structure having a fixed length, and the like because data sizes can be communized. Furthermore, it is possible to more appropriately determine whether the query result is successful on the basis of the aforementioned query result satisfaction level acquired using a data size.

In addition, in embodiments, it is possible to extract devices 300 from a plurality of devices 300 under the control of the gateway 200 in accordance with a predetermined group condition, form at least one group using the extracted devices, execute a query in units of formed groups, and calculate a satisfaction level or the like. For example, the predetermined group condition may be an area, or the type and numbers of devices 300. Furthermore, in embodiments, grouping may be performed on device IDs basis or on gateway IDs basis.

For example, an administrator or the like of the server 100 sets grouping such as “all devices 300 in Kawasaki” in advance. The message broker 410 of the server side includes information for identifying a group in a query to be transmitted and transmits the query to the gateway 200. Accordingly, the message broker 420 of the gateway side can transmit the query only to devices 300 included in the set group.

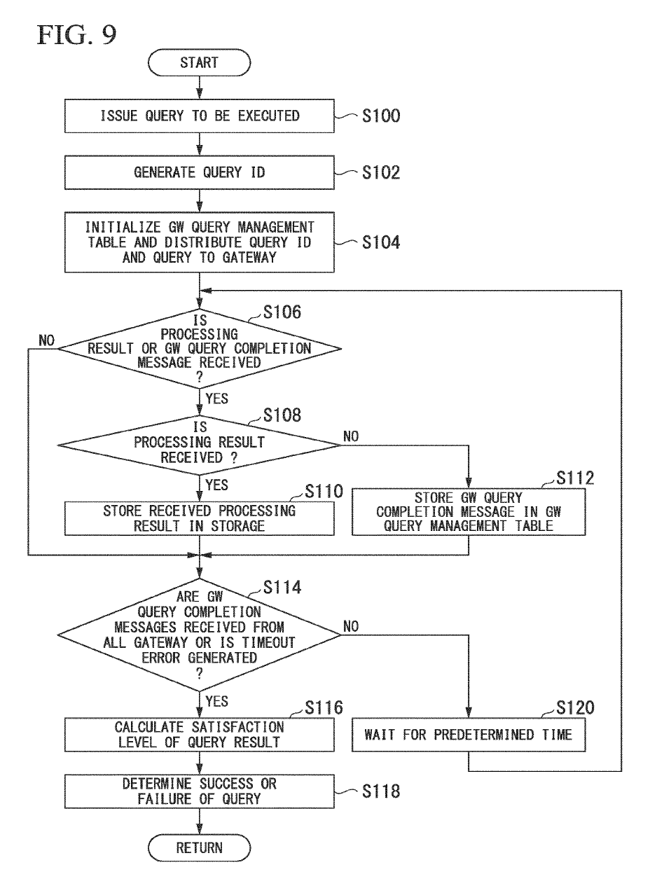

Next, content of various processes of the server 100 of the embodiments will be described in detail using a flowchart. FIG. 9 is a flowchart illustrating an example of content of a process in the server 100 of embodiments. The process illustrated in FIG. 9 is repeatedly performed whenever a query is executed.

In the example of FIG. 9, the retriever 110 issues a query to be executed (step S100) and generates a query ID corresponding to the issued query (step S102).

Then, the distributor 120 initializes a GW query management table and distributes the query ID and the query to the gateway 200 (step S104). Subsequently, the processing state receptor 130 determines whether a processing result with respect to the query or a GW query completion message is received from the gateway 200 (step S106).

When the processing result with respect to the query (query result) or the GW query completion message is received from the gateway 200, the processing state receptor 130 determines whether the processing result is received (step S108). When the processing result is received, the processing state receptor 130 stores the received processing result in the storage 150 (step S110). In addition, when the processing result is not received in step S108, the GW query completion message is received and thus the processing state receptor 130 stores the GW query completion message in the GW query management table (step S112). For example, the GW query completion message is a satisfaction level corresponding to the gateway 200.

After the processes of step S110 and step S112, the processing state receptor 130 determines whether GW query completion messages are received from all the gateways 200 or a timeout error is generated (step S114). With respect to the timeout error, for example, a time from distribution of the query to the gateways 200 until the GW query completion messages are received is set and excess of the time is determined as a timeout error.

When the GW query completion messages are received from all the gateways 200 or the timeout error is generated, the completion determiner 140 calculates a satisfaction level in the entire query (step S116) and determines success or failure of the query on the basis of the calculated value and a threshold value (step S118). For example, when the calculated satisfaction level of the query result is equal to or greater than the threshold value, it is possible to determine that the query has succeeded. Accordingly, the process of this flowchart ends.

On the other hand, when the GW query completion messages are not received from all the gateways or the timeout error is not generated in the aforementioned process of step S114, the processing state receptor 130 waits for a predetermined time (step S120) and returns to the process of step S106.

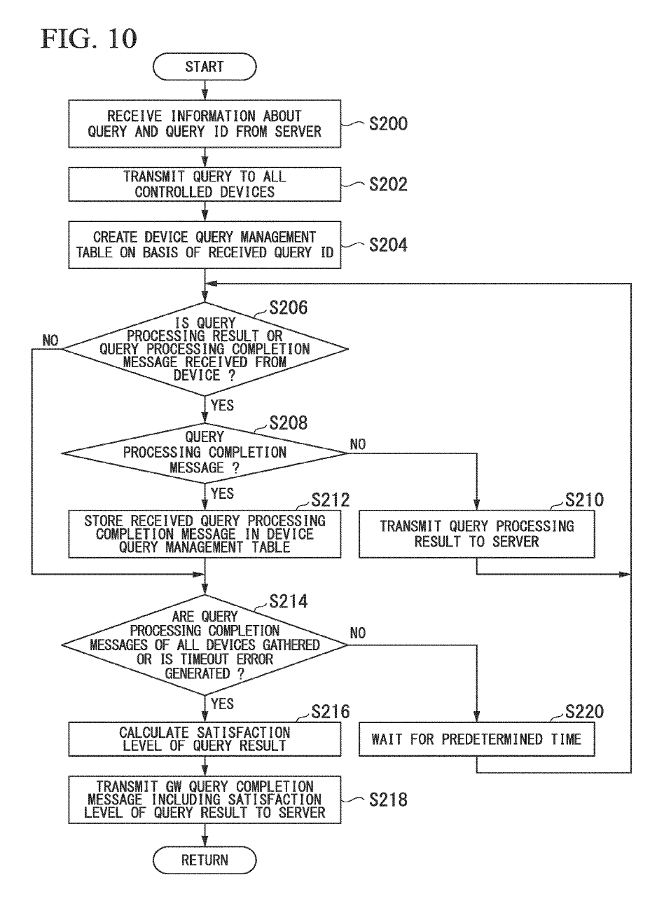

Next, content of various processes of the gateway 200 of embodiments will be described in detail using a flowchart. FIG. 10 is a flowchart illustrating an example of content of a process in the gateway 200 of the embodiments. The process illustrated in FIG. 10 is repeatedly executed whenever the gateway 200 receives a query distributed from the server 100.

In the example of FIG. 10, the transceiver 210 receives information about a query and a query ID from the server 100 (step S200). Then, the process manager 220 causes the transceiver 210 to transmit the query to all the controlled devices 300 (step S202). Subsequently, the process manager 220 creates the device query management table 242 on the basis of the received query ID (step S204).

Thereafter, the process manager 220 determines whether a query processing result or a query processing completion message is received from the device 300 (step S206). When the query processing result or the query processing completion message is received, the process manager 220 determines whether the received information is the query processing completion message (step S208). If the received information is not the query processing completion message, the received information is the query processing result and thus the transceiver 210 transmits the query processing result to the server 100 (step S210) and returns to the process of step S206.

When the received information is the query processing completion message (step S208), the process manager 220 stores the received query processing completion message in the device query management table 242 (step S212).

Then, the process manager 220 determines whether query processing completion messages of all the devices 300 are gathered or a timeout error is generated (step S214). When the query processing completion messages of all the devices 300 are gathered or the timeout error is generated, the processing state transmission controller 230 calculates a satisfaction level with respect to query results in the controlled devices 300 (step S216) and causes the transceiver 210 to transmit a GW query completion message including the satisfaction level of the query results to the server 100 (step S218). Accordingly, the process of this flowchart ends.

Meanwhile, when the query processing completion messages from all the devices 300 are not gathered and the timeout error is not generated in the aforementioned process of step S214, the process manager 220 waits for a predetermined time (step S220) and returns to the process of step S206.

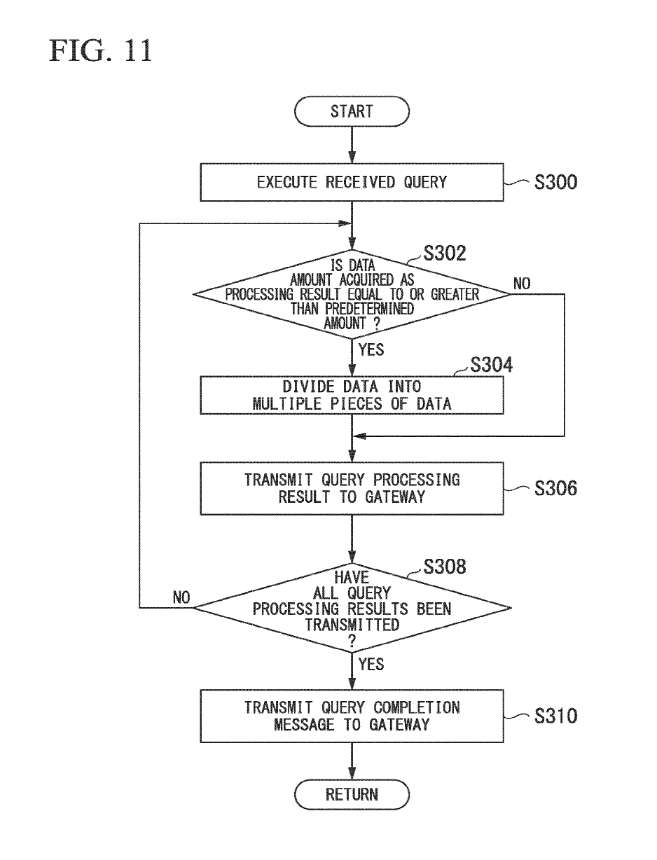

Next, content of various processes of the device 300 of embodiments will be described in detail using a flowchart. FIG. 11 is a flowchart illustrating an example of content of a process in the device 300 of embodiments. The process illustrated in FIG. 11 is repeatedly executed whenever the device 300 receives a query transmitted from the gateway 200.

In the example of FIG. 11, when a query is received from the gateway 200, the query executioner 320 executes the received query (step S300). Then, the query executioner 320 determines whether a data amount acquired as a processing result of the query is equal to or greater than a predetermined amount (step S302). For example, the predetermined amount is a data amount standardized in transmitted messages, but the present invention is not limited thereto. When the data amount is equal to or greater than the predetermined amount, the query executioner 320 divides the data amount acquired as the processing result into a plurality of pieces of data (step S304).

Subsequently, the transceiver 310 transmits the query processing result to the gateway (step S306). In the aforementioned process of step S304, when the data is divided, the transceiver 310 transmits the query processing result to the gateway 200 for each piece of the divided data.

Thereafter, the query executioner 320 determines whether all query processing results are transmitted (step S308). When all the query processing results are not transmitted, the process returns to step S302. In addition, when all the query processing results are transmitted, a query completion message is transmitted to the gateway 200 (step S310). Accordingly, the process of this flowchart ends.

Here, for example, when a certain device 300 is down or disconnected during C transmission in the data retrieval system 1 of embodiments, the processing state receptor 130 may regard part of query results transmitted so far to be valid or invalid. In addition, the data retrieval system 1 may install a bridge process instead of the aforementioned query control process 430 illustrated in FIG. 4 in the gateway 200 and buffer query results from the device 300. In this case, the gateway 200 temporarily retains query results according to the bridge process and, when a query processing completion message is received from the device 300, transmits the retained query results collectively to the server 100. Accordingly, the server 100 can acquire all query results for each device 300 and thus the accuracy of a query result satisfaction level can be improved.

For example, it is possible to perform the following determination by using the data retrieval system 1 of the above-described embodiments. For example, the retriever 110 of the server 100 causes the gateway 200 to distribute a query for acquiring a power consumption amount of the present time with respect to the device 300. In addition, it is assumed that the server 100 has acquired 90% of devices 300 in an area to which the query has been distributed from the gateway 200. Since 90% is equal to or greater than a preset threshold value (e.g., 80%), the completion determiner 140 of the server 100 determines that this query has succeeded.

Furthermore, when the total power consumption amount of 90% of the devices 300 is 1.2 [MWh], the completion determiner 140 estimates that the total power consumption amount of all devices 300 is 1.2×10/9≈1.33 [MWh]. In addition, the completion determiner 140 compares the estimated power consumption amount with a threshold value with respect to power consumption amounts to determine whether excessive electric power is used. For example, when the estimated power consumption amount is equal to or greater than the threshold value, the completion determiner 140 determines that excessive electric power is used and may perform a process of temporarily increasing a power-saving cooperation charge, and the like. Hence, according to the data retrieval system 1 of embodiments, since general conditions of a power consumption amount of the present time, for example, can be acquired, even if some query results are not obtained, it is possible to perform an appropriate process for the entire system by recognizing general conditions in a certain range.

Further, when query results from only 70% of the devices 300 of the area to which the query has been distributed are acquired from the gateway 200 in the above-described example, the percentage is equal to or lower than the threshold value (e.g., 80%), and thus the completion determiner 140 of the server 100 determines that this query has failed and does not perform the subsequent process. Accordingly, the data retrieval system 1 can suppress processes using unreliable data and thus the processing load of the entire system can be reduced.

According to at least one of the above-described embodiments, the data retrieval system 1 includes: the server 100; and the gateway 200, wherein the server 100 has the distributor 120 that distributes a query to one or more devices 300 capable of retaining data, the processing state receptor 130 that receives, from the gateway 200, information indicating processing states of the one or more devices 300 with respect to the query, and the completion determiner 140 that determines whether the query is completed from the processing states received by the processing state receptor 130, and the gateway 200 has the transceiver 210 that receives the query distributed by the server 100 and transmits the query to the one or more devices 300, the process manager 220 that manages a processing state indicating whether each of the one or more devices completes the query on the basis of a query processing result of each of the one or more devices 300 that is received through the transceiver 210, and the processing state transmission controller 230 that transmits query processing states managed by the process manager 220 to the server 100 using the transceiver 210, and thus data distributed to the devices 300 can be retrieved with high efficiency and the processing load of the server 100 can be reduced.

Specifically, according to at least one of the embodiments, the server 100 can perform query management in the gateway 200. In addition, according to at least one of the embodiments, it is possible to rapidly recognize whether a query has succeeded on the basis of a satisfaction degree calculated for each gateway 200. Accordingly, the server 100 need not manage processing states of all devices 300. Therefore, the processing load of the server 100 can be reduced.

Furthermore, according to at least one of the embodiments, it is possible to rapidly perform parallel retrieval processes for a plurality of devices 300. In addition, according to at least one of the embodiments, it is possible to appropriately manage “quality” with respect to query results. Moreover, according to at least one of the embodiments, it is possible to manage which device completes query processing and to determine the reliability of a query result.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

1. A data retrieval system comprising a first apparatus and a second apparatus,
wherein the first apparatus comprises:
a distributor which distributes a query to one or more devices that are able to retain data;
a processing state receptor which receives, from the second apparatus, information indicating processing states of the one or more devices for the query; and
a completion determiner which determines whether the query is complete from the processing state received by the processing state receptor, and
the second apparatus comprises:
a transceiver which receives a query distributed by the first apparatus and transmits the query to the one or more devices;
a process manager which manages a processing state indicating whether each of the one or more devices completes the query on the basis of a processing result of the query of each of the one or more devices received by the transceiver; and
a processing state transmission controller which transmits processing states of the query managed by the process manager to the first apparatus using the transceiver.

2. The data retrieval system according to claim 1, wherein the process manager calculates a satisfaction level with respect to a result of the query on the basis of a ratio of devices which complete a process for the query from among the one or more devices to which the query has been transmitted, and
the processing state transmission controller transmits the satisfaction level to the first apparatus as the processing state using the transceiver.

3. The data retrieval system according to claim 2, wherein the completion determiner determines whether the query has succeeded on the basis of a satisfaction degree with respect to the result of the query of the second apparatus.

4. The data retrieval system according to claim 2, wherein the completion determiner determines that the query has succeeded when a value obtained by dividing a total sum of satisfaction degrees with respect to results of the query of each of the second apparatus by the number of second apparatuses is equal to or greater than a threshold value.

5. The data retrieval system according to claim 2, wherein the processing state transmission controller transmits information about the number of one or more devices to which the query has been transmitted together with the satisfaction degree as the processing state to the first apparatus using the transceiver, and
the completion determiner determines that the query has succeeded when a value obtained by dividing the sum of products of satisfaction degrees of each of the second apparatus and the number of devices by the number of devices is equal to or greater than a threshold value.

6. The data retrieval system according to claim 2, wherein the process manager calculates a satisfaction degree with respect to the result of the query on the basis of a data size of data retained in each of the one or more devices and a data size of data retained in a device which completes a process for the query.

7. The data retrieval system according to claim 1, wherein the distributor distributes the query to devices grouped in accordance with a predetermined group condition among the one or more devices that are able to retain data.

8. A data retrieval method comprising:
by a first apparatus,
distributing a query to one or more devices that are able to retain data;
receiving, from a second apparatus, information indicating processing states of the one or more devices for the query; and
determining whether the query is complete from the received processing state, and
by the second apparatus,
receiving a query distributed by the first apparatus and transmitting the query to the one or more devices;
managing a processing state indicating whether each of the one or more devices completes the query on the basis of a processing result of the query of each of the one or more devices received from the one or more devices; and
transmitting managed processing states of the query to the first apparatus.
